(19) United States
(12) Patent Application Publication
(10) Pub. No.: US 2025/0303968 A1
(43) Pub. Date: Oct. 2, 2025

(54) PASSENGER INGRESS AND EGRESS ASSISTANCE APPARATUS

(71) Applicants: Hyundai Motor Company, Seoul (KR); Kia Corporation, Seoul (KR)

(72) Inventors: Kyu Hoon Cho, Hwaseong-si (KR); Hyoung Hwan Lim, Bucheon-si (KR)

(21) Appl. No.: 18/822,886

(22) Filed: Sep. 3, 2024

(30) Foreign Application Priority Data
Mar. 28, 2024 (KR) 10-2024-0042700

(51) Int. Cl. B60R 3/02

(52) U.S. Cl. CPC B60R 3/02

(57) ABSTRACT

An embodiment passenger ingress and egress assistance apparatus includes a case having a cavity defined therein, a moving body configured to move in the cavity of the case in a longitudinal direction of the case, a platform configured to be stowed in and deployed from the cavity of the case by a movement of the moving body, a hinge mechanism configured to pivotally connect the platform to the moving body, and a step device disposed at a leading portion of the platform, the step device including a step body that is parallel to the platform and a plurality of step bars pivotally connecting the step body to the leading portion of the platform.

### CROSS-REFERENCE TO RELATED APPLICATIONS

This application claims the benefit of Korean Patent Application No. 10-2024-0042700, filed on Mar. 28, 2024, which application is hereby incorporated herein by reference in its entirety.

### TECHNICAL FIELD

The present disclosure relates to a passenger ingress and egress assistance apparatus.

### BACKGROUND

Passenger ingress and egress assistance apparatuses designed to assist in the ingress and egress of various types of passengers including ordinary passengers and passengers with disabilities may have various structures. Such passenger ingress and egress assistance apparatuses may be classified into various operating systems such as an automated step, a slope apparatus, a lifting apparatus, and a ramp apparatus.

In electric vehicles and autonomous vehicles, a battery may be disposed under the floor of the vehicle, and accordingly the passenger ingress and egress assistance apparatus may need to be stacked on a top surface of the floor considering an overlapping layout of the passenger ingress and egress assistance apparatus and the battery.

When the passenger ingress and egress assistance apparatus is stacked on the top surface of the floor, a step height may increase, which may cause inconvenience in the ingress and egress of ordinary passengers. That is, while the passenger ingress and egress assistance apparatus according to the related art is advantageous to passengers with disabilities, it may be disadvantageous to ordinary passengers. In addition, the slope apparatus of the related art passenger ingress and egress assistance apparatuses may be difficult to meet North American regulations for wheelchair transportation safety if the height of the vehicle floor is increased.

The above information described in this background section is provided to assist in understanding the background of the inventive concept and may include any technical concept which is not considered as the already known prior art.

### SUMMARY

The present disclosure relates to a passenger ingress and egress assistance apparatus. Particular embodiments relate to a passenger ingress and egress assistance apparatus providing assistance in ingress and egress of various types of passengers.

Embodiments of the present disclosure can solve problems occurring in the prior art while advantages achieved by the prior art are maintained intact.

An embodiment of the present disclosure provides a passenger ingress and egress assistance apparatus designed to comprehensively assist in the ingress and egress of various types of passengers.

According to an embodiment of the present disclosure, a passenger ingress and egress assistance apparatus may include a case having a cavity defined therein, a moving body configured to move in the cavity of the case in a longitudinal direction of the case, a platform configured to be stowed in and deployed from the cavity of the case by a movement of the moving body, a hinge mechanism configured to pivotally connect the platform to the moving body, and a step device provided at a leading portion of the platform. The step device may include a step body that is parallel to the platform and a plurality of step bars pivotally connecting the step body to the leading portion of the platform.

The step body may be configured to move between a retracted position in which the step body is overlapped with the leading portion of the platform and an extended position in which the step body is extended from the leading portion of the platform.

A top end of each step bar may be pivotally connected to the platform through a pivot pin, and a bottom end of each step bar may be pivotally connected to the step body through a pivot pin.

The plurality of step bars may include a first step bar and a second step bar connecting the platform and the step body. The step device may further include an actuator configured to move the first step bar.

The step device may further include a slider bar pivotally connecting the second step bar to the step body.

The step device may further include a safety cover pivotally mounted on a leading portion of the step body. The safety cover may be configured to move between a cover position in which the safety cover is vertically unfolded to cover a leading opening of the step body and an uncover position in which the safety cover is folded toward the step body to uncover the leading opening of the step body.

The step device may further include a link mechanism operably connected to the second step bar.

The link mechanism may include a cover pin connected to the safety cover, a first link pivotally connected to the cover pin, a second link pivotally connected to the first link, and a spring elastically connecting the second link and the second step bar.

The passenger ingress and egress assistance apparatus may further include a moving mechanism configured to move the safety cover to the uncover position when the platform is close to the ground.

The safety cover may include a guide projection protruding from a bottom edge thereof, and the guide projection may extend in a direction inclined with respect to the safety cover at a predetermined angle.

The moving mechanism may include a wheel assembly configured to move between an upward position in which the wheel assembly pushes the guide projection and a downward position in which the wheel assembly is spaced apart downward from the guide projection and a guide bracket guiding the upward and downward movement of the wheel assembly. The guide bracket may be fixed to the step body.

The wheel assembly may include a pair of legs spaced apart from each other, a wheel rotatably mounted between bottom ends of the pair of legs, and a guide pin mounted between top ends of the pair of legs.

The guide bracket may include a pair of side walls and a top wall connecting top ends of the pair of side walls. Each side wall may have a guide slot extending vertically, and the guide pin of the wheel assembly may be configured to move along the guide slot.

The step device may further include a skirt pivotally mounted on a bottom edge of the safety cover.

The skirt may include a roller device provided at a bottom edge thereof.

The roller device may include a bracket fixed to the bottom edge of the skirt and a roller rotatably mounted on the bracket.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a passenger ingress and egress assistance apparatus according to an exemplary embodiment of the present disclosure, which is mounted on a floor of a vehicle;

FIG. 2 illustrates a case of a passenger ingress and egress assistance apparatus according to an exemplary embodiment of the present disclosure, which is mounted on a floor of a vehicle using brackets;

FIG. 3 illustrates an exploded perspective view of a passenger ingress and egress assistance apparatus according to an exemplary embodiment of the present disclosure;

FIG. 4 illustrates a perspective view of a passenger ingress and egress assistance apparatus according to an exemplary embodiment of the present disclosure, from which an upper case is removed;

FIG. 5 illustrates an enlarged view of a trailing portion of a case in the passenger ingress and egress assistance apparatus illustrated in FIG. 4;

FIG. 6 illustrates a plan view of a passenger ingress and egress assistance apparatus according to an exemplary embodiment of the present disclosure, from which an upper case is removed;

FIG. 7 illustrates a cross-sectional view, taken along line A-A of FIG. 6;

FIG. 8 illustrates a plan view of a state in which a platform is deployed from a case in a passenger ingress and egress assistance apparatus according to an exemplary embodiment of the present disclosure;

FIG. 9 illustrates a cross-sectional view, taken along line B-B of FIG. 8;

FIG. 10 illustrates a state in which a step body of a step device is in a retracted position in a passenger ingress and egress assistance apparatus according to an exemplary embodiment of the present disclosure;

FIG. 11 illustrates a state in which a step body of a step device is in an extended position in a passenger ingress and egress assistance apparatus according to an exemplary embodiment of the present disclosure;

FIG. 12 illustrates an enlarged view of a portion of the step device illustrated in FIG. 11;

FIG. 13 illustrates a perspective view of the step device illustrated in FIG. 12, from which a plurality of step bars and a link mechanism are removed;

FIG. 14 illustrates a perspective view of a state in which a safety cover and a skirt are pivotally mounted on a leading portion of a step body of a step device in a passenger ingress and egress assistance apparatus according to an exemplary embodiment of the present disclosure;

FIG. 15 illustrates a state in which a step body of a step device is in an extended position in a passenger ingress and egress assistance apparatus according to an exemplary embodiment of the present disclosure;

FIG. 16 illustrates a perspective view of a state in which a platform is deployed from a case in a passenger ingress and egress assistance apparatus according to an exemplary embodiment of the present disclosure;

FIG. 17 illustrates an exploded perspective view of a hinge mechanism, a platform, a first lift bar, a second lift bar, and a bracket assembly in a passenger ingress and egress assistance apparatus according to an exemplary embodiment of the present disclosure;

FIG. 18 illustrates an exploded perspective view of a shaft, a bracket assembly, and a first lift bar in a passenger ingress and egress assistance apparatus according to an exemplary embodiment of the present disclosure;

FIG. 19 illustrates a perspective view of a state in which a first lift bar is connected to a bracket assembly in a passenger ingress and egress assistance apparatus according to an exemplary embodiment of the present disclosure;

FIG. 20 illustrates an exploded perspective view of a state in which a first lift bar and a second lift bar are connected to a bracket assembly and a shaft in a passenger ingress and egress assistance apparatus according to an exemplary embodiment of the present disclosure;

FIG. 21 illustrates a perspective view of a clutch device and a bracket assembly in a passenger ingress and egress assistance apparatus according to an exemplary embodiment of the present disclosure;

FIG. 22 illustrates a perspective view, which is viewed in a direction indicated by arrow C illustrated in FIG. 21;

FIG. 23 illustrates an exploded perspective view of a clutch device in a passenger ingress and egress assistance apparatus according to an exemplary embodiment of the present disclosure;

FIG. 24 illustrates a state in which a bracket assembly is locked to a moving body and a first lift bar is unlocked from the bracket assembly in a passenger ingress and egress assistance apparatus according to an exemplary embodiment of the present disclosure;

FIG. 25 illustrates a state in which a platform moves to a downward horizontal position in a lift mode of a passenger ingress and egress assistance apparatus according to an exemplary embodiment of the present disclosure;

FIG. 26 illustrates a state in which a bracket assembly is unlocked from a moving body and a first lift bar is locked to the bracket assembly in a passenger ingress and egress assistance apparatus according to an exemplary embodiment of the present disclosure;

FIG. 27 illustrates a state in which a platform moves to an inclined position in a slope mode of a passenger ingress and egress assistance apparatus according to an exemplary embodiment of the present disclosure;

FIG. 28 illustrates a state in which a wheel assembly of a moving mechanism is spaced apart from the ground in a passenger ingress and egress assistance apparatus according to an exemplary embodiment of the present disclosure; and

FIG. 29 illustrates a state in which a wheel assembly of a moving mechanism contacts the ground in a passenger ingress and egress assistance apparatus according to an exemplary embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with embodiments of the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence, order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

A passenger ingress and egress assistance apparatus according to exemplary embodiments of the present disclosure may be configured to operate in various modes so as to actively assist in ingress and egress of various types of passengers including ordinary passengers and passengers with disabilities.

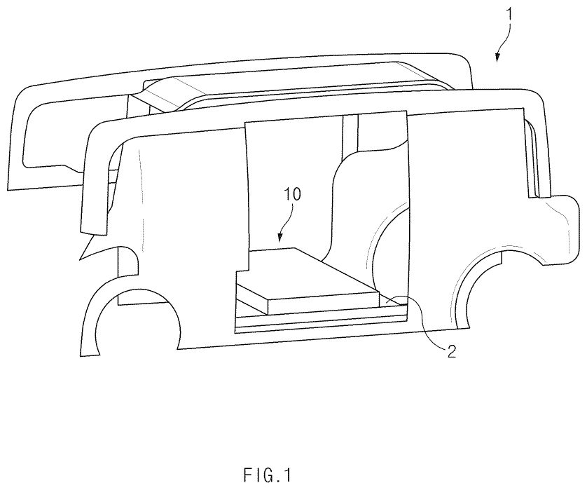

Referring to FIG. 1, a passenger ingress and egress assistance apparatus 10 according to an exemplary embodiment of the present disclosure may be mounted on a top surface of a floor 2 of a vehicle 1 and may be configured to operate in various modes to provide assistance in the ingress and egress of various types of passengers (ordinary passengers, passengers with disabilities, passengers who use wheelchairs, and the like) when a door of the vehicle 1 is opened.

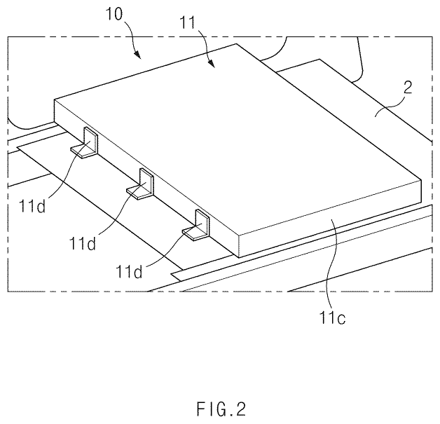

Referring to FIGS. 1 and 2, the passenger ingress and egress assistance apparatus 10 according to an exemplary embodiment of the present disclosure may include a case 11 having a cavity defined therein. The case 11 may have a trailing portion facing the interior of the vehicle, and a leading portion facing the exterior of the vehicle. The case 11 may have a leading opening provided in the leading portion thereof, and the case 11 may be open to the exterior of the vehicle through the leading opening. The case 11 may have a gate 11c mounted on the leading portion to open and close. A bottom edge of the gate 11c may be pivotally mounted on a bottom edge of the leading opening of the case 11 through a pivot pin, and the gate 11c may be configured to move between an open position and a closed position. The gate 11c may be biased to the closed position by a biasing member (not shown) such as a torsion spring.

Referring to FIG. 2, the case 11 may be fixed to the floor 2 of the vehicle 1 through a plurality of brackets 11d. Each bracket 11d may have an L-shaped cross section.

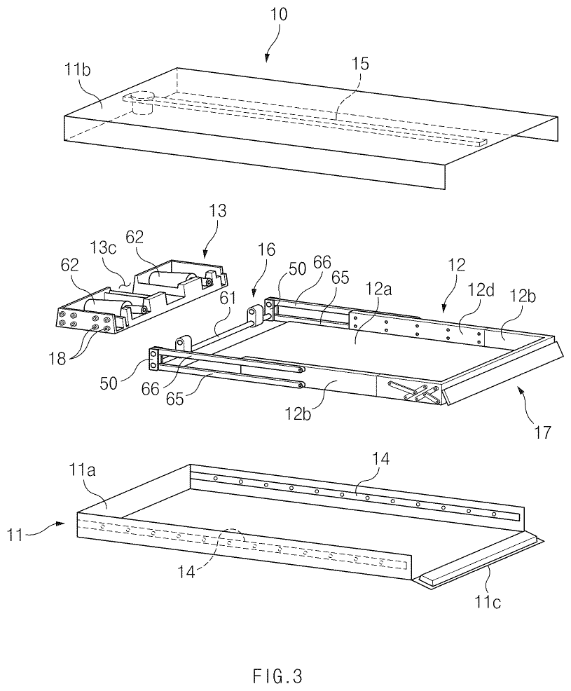

Referring to FIG. 3, the case 11 may include a lower case 11a and an upper case 11b covering the top of the lower case 11a. The cavity of the case 11 may be defined by the lower case 11a and the upper case 11b.

Referring to FIG. 3, a pair of track rails 14 may be provided on both side walls of the lower case 11a of the case 11, and each track rail 14 may extend in a longitudinal direction of the case 11.

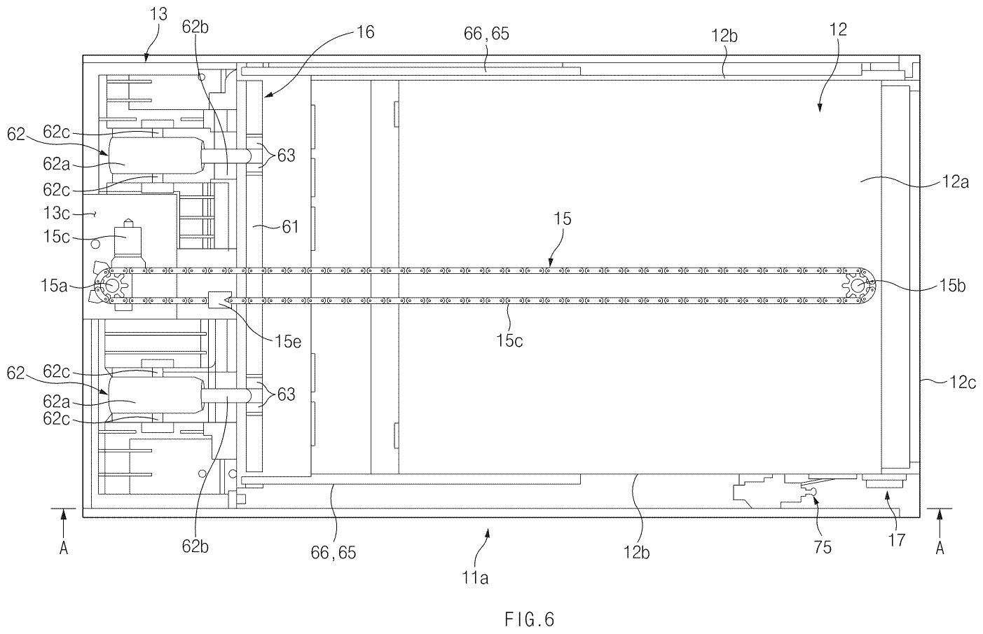

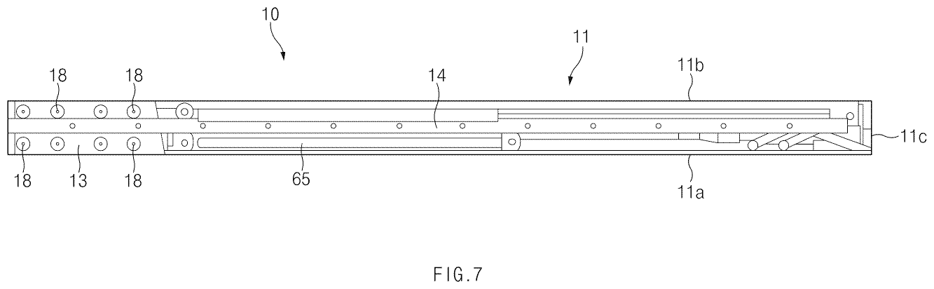

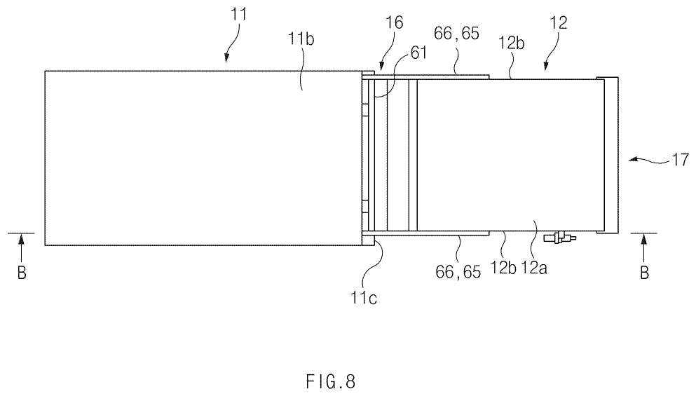

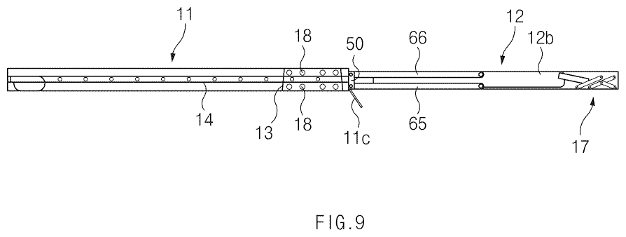

Referring to FIG. 3, the passenger ingress and egress assistance apparatus 10 according to an exemplary embodiment of the present disclosure may include a platform 12 configured to be stowed in and deployed from the cavity of the case 11. The platform 12 may be configured to move between a deployed position (see FIGS. 8 and 9) in which the platform 12 is fully deployed horizontally from the cavity of the case 11 and a stowed position (see FIGS. 6 and 7) in which the platform 12 is fully stowed horizontally in the cavity of the case 11. When the platform 12 is in the deployed position (see FIG. 9), the platform 12 may be horizontally aligned with the cavity of the case 11. When the platform 12 moves to the deployed position, the platform 12 may push the gate 11c of the case 11 out so that the gate 11c may move to the open position by overcoming a biasing force of the biasing member. The platform 12 may have a trailing portion facing the interior of the vehicle and a leading portion facing the exterior of the vehicle. The platform 12 may include a bottom wall 12a and a pair of side walls 12b provided on both side edges of the bottom wall 12a.

Referring to FIG. 3, the passenger ingress and egress assistance apparatus 10 according to an exemplary embodiment of the present disclosure may include a moving body 13 connected to the trailing portion of the platform 12. The moving body 13 may have an opening 13c defined in the center thereof. The moving body 13 may be configured to move in the cavity of the case 11 in the longitudinal direction of the case 11, and accordingly the moving body 13 may move between the leading portion of the case 11 and the trailing portion of the case 11 in the cavity of the case 11. Referring to FIGS. 6 and 7, the moving body 13 may be close to the leading portion of the case 11 in the cavity of the case 11. Referring to FIGS. 8 and 9, the moving body 13 may be close to the trailing portion of the case 11 in the cavity of the case 11.

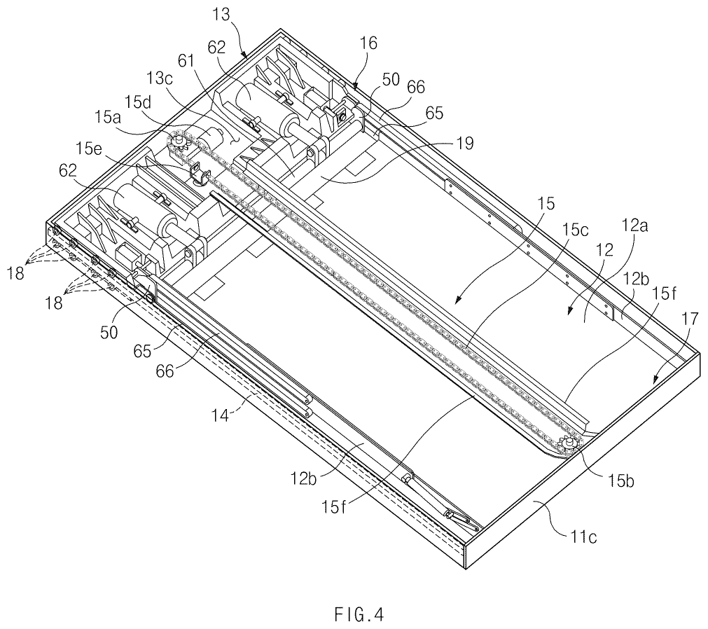

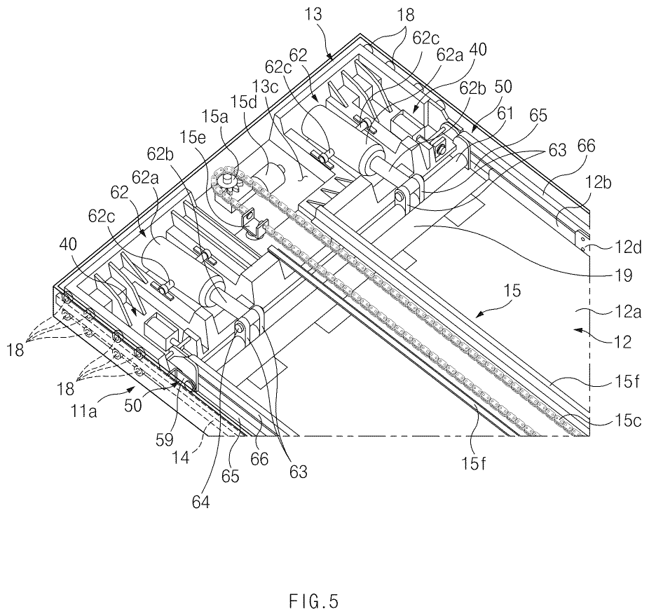

Referring to FIGS. 4 and 5, the moving body 13 may have a plurality of wheels 18 rotatably mounted on both side surfaces thereof, and the wheels 18 of the moving body 13 may be configured to be in rolling contact with the track rails 14 of the case 11. Referring to FIGS. 7 and 9, the plurality of wheels 18 may be in rolling contact with a top surface of the track rail 14 and a bottom surface of the track rail 14.

Referring to FIG. 3, the passenger ingress and egress assistance apparatus 10 according to an exemplary embodiment of the present disclosure may include a driver 15 configured to move the platform 12 and the moving body 13 in the longitudinal direction of the case 11. The driver 15 may be disposed in the cavity of the case 11, and the driver 15 may be configured to move the moving body 13 in the longitudinal direction of the case 11. As the driver 15 moves the moving body 13 in the longitudinal direction of the case 11, the platform 12 may move between the stowed position and the deployed position by the driver 15 and the moving body 13. A length of the platform 12 to be deployed from the case 11 may be adjusted by the driver 15 and the moving body 13.

Referring to FIG. 4, the driver 15 may include a drive sprocket 15a adjacent to the trailing portion of the case 11, a driven sprocket 15b adjacent to the leading portion of the case 11, a chain 15c connecting the drive sprocket 15a and the driven sprocket 15b, and a motor 15d driving the drive sprocket 15a.

The drive sprocket 15a may be driven by the motor 15d, and the drive sprocket 15a and the driven sprocket 15b may be rotatably mounted on the upper case 11b.

The motor 15d may be located in the opening 13c of the moving body 13, and the motor 15d may be mounted on the lower case 11a of the case 11. The motor 15d may be a bidirectional motor operating clockwise and counterclockwise, and the drive sprocket 15a may rotate clockwise and counterclockwise by the motor 15d.

The chain 15c may include a chain attachment 15e connecting two adjacent chain elements of a plurality of chain elements. Referring to FIG. 5, the chain attachment 15e may have a U-like shape, and the chain attachment 15e may be fixed to the moving body 13 using fasteners, welding, and/or the like.

The driver 15 may further include a pair of guide members 15f guiding a movement of the chain 15c. The pair of guide members 15f may be disposed on both sides of the chain 15c, and the pair of guide members 15f may be mounted on the upper case 11b of the case 11.

The passenger ingress and egress assistance apparatus 10 according to an exemplary embodiment of the present disclosure may include a hinge mechanism 16 configured to pivotally connect the platform 12 to the moving body 13. Referring to FIGS. 4 and 5, the hinge mechanism 16 may include a shaft 61 located between the moving body 13 and the platform 12 and an actuator 62 rotating the shaft 61. The shaft 61 may extend in a width direction of the case 11, and the shaft 61 may be connected to the platform 12. The actuator 62 may be configured to rotate the shaft 61.

The shaft 61 may have a plurality of arms 63 protruding from an exterior surface thereof, and an end of each arm 63 may be offset from a longitudinal axis of the shaft 61.

The actuator 62 may be configured to push and pull the arms 63 of the shaft 61. As the arms 63 move linearly around the central longitudinal axis of the shaft 61, the shaft 61 may rotate around the longitudinal axis thereof.

According to an exemplary embodiment, the actuator 62 may be a hydraulic or pneumatic cylinder. The actuator 62 may include a housing 62a pivotally mounted with respect to the moving body 13 and a rod 62b moving forward and backward with respect to the housing 62a. Referring to FIGS. 3 to 5, two actuators 62 may be mounted on the moving body 13, and each actuator 62 may be connected to the arms 63 of the shaft 61.

The housing 62a may have a pair of pivot pins 62c provided on both sides thereof, and the pivot pins 62c may be rotatably mounted on the moving body 13. Accordingly, the housing 62a may pivot with respect to the moving body 13 through the pivot pins 62c.

The rod 62b of the actuator 62 may be pivotally connected to the arms 63 of the shaft 61 through a pivot pin 64. As the rod 62b of the actuator 62 moves forward, the arms 63 of the shaft 61 may move toward the platform 12, and the housing 62a may pivot toward the platform 12 so that the shaft 61 may rotate clockwise. As the rod 62b of the actuator 62 moves backward, the arms 63 of the shaft 61 may move toward the moving body 13, and the housing 62a may pivot toward the moving body 13 so that the shaft 61 may rotate counterclockwise.

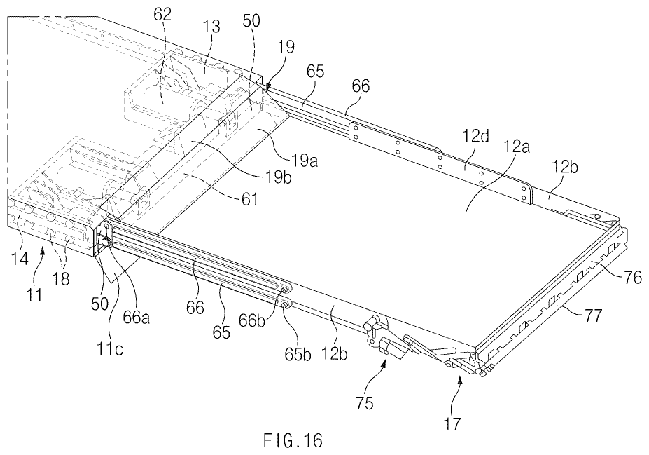

Referring to FIG. 16, the passenger ingress and egress assistance apparatus 10 according to an exemplary embodiment of the present disclosure may further include a ramp cover 19 pivotally mounted on the trailing portion of the platform 12. The ramp cover 19 may include an inclined portion 19a inclined at a predetermined angle and an upper portion 19b bent from the inclined portion 19a at a predetermined angle. The ramp cover 19 may be configured to move between a folded position in which the ramp cover 19 is folded toward the bottom wall 12a of the platform 12 and an unfolded position in which the ramp cover 19 is unfolded toward a top surface of the case 11. The ramp cover 19 may be biased to the unfolded position by a biasing member (not shown) such as a torsion spring. When the platform 12 is fully deployed from the case 11, the ramp cover 19 may be unfolded toward the top surface of the case 11 since a force is not applied to the ramp cover 19 so that the ramp cover 19 may bridge a height difference between the top surface of the case 11 and the bottom wall 12a of the platform 12.

Referring to FIG. 3, the passenger ingress and egress assistance apparatus 10 according to an exemplary embodiment of the present disclosure may include a step device 17 provided at the leading portion of the platform 12.

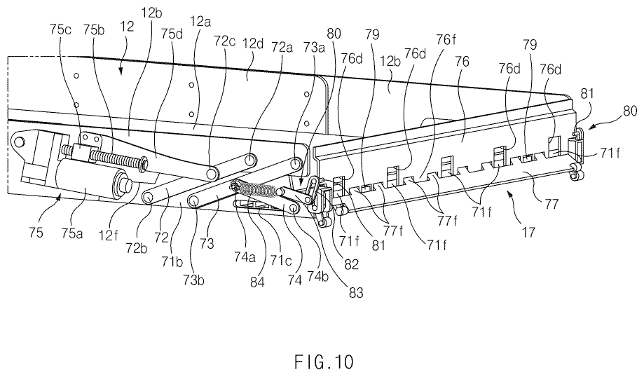

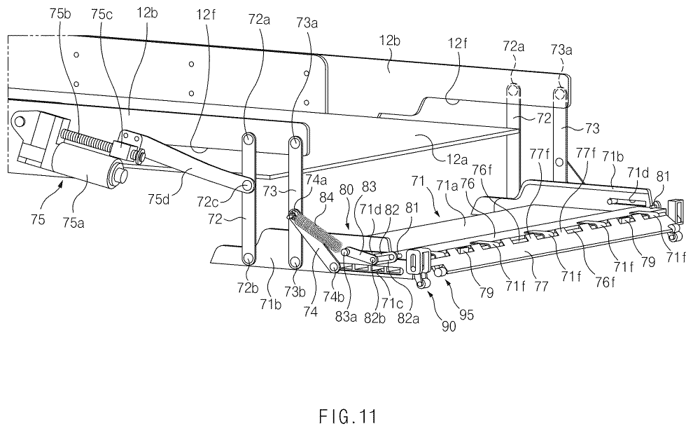

Referring to FIGS. 10 and 11, the step device 17 may include a step body 71 that is parallel to the platform 12 and a plurality of step bars 72 and 73 pivotally connecting the step body 71 to the leading portion of the platform 12.

The step body 71 may be configured to move between a retracted position (see FIG. 10) in which the step body 71 is overlapped with the leading portion of the platform 12 and an extended position (see FIG. 11) in which the step body 71 is extended out from the leading portion of the platform 12. The step body 71 may include a bottom wall 71a and a pair of side walls 71b provided on both sides of the bottom wall 71a. The bottom wall 71a of the step body 71 may be parallel to the bottom wall 12a of the platform 12. Each side wall 12b of the platform 12 may have an opening 12f formed in the leading portion thereof, and each side wall 71b of the step body 71 may be shaped to match the opening 12f of the side wall 12b of the platform 12. When the step body 71 is in the retracted position, the bottom wall 71a of the step body 71 may contact or may be close to a bottom surface of the bottom wall 12a of the platform 12, and each side wall 71b of the step body 71 may be received in the opening 12f of the corresponding side wall 12b of the platform 12. When the step body 71 is in the extended position, the bottom wall 71a of the step body 71 may be spaced apart downward from the bottom surface of the bottom wall 12a of the platform 12, and each side wall 71b of the step body 71 may be spaced apart downward from the opening 12f of the corresponding side wall 12b of the platform 12.

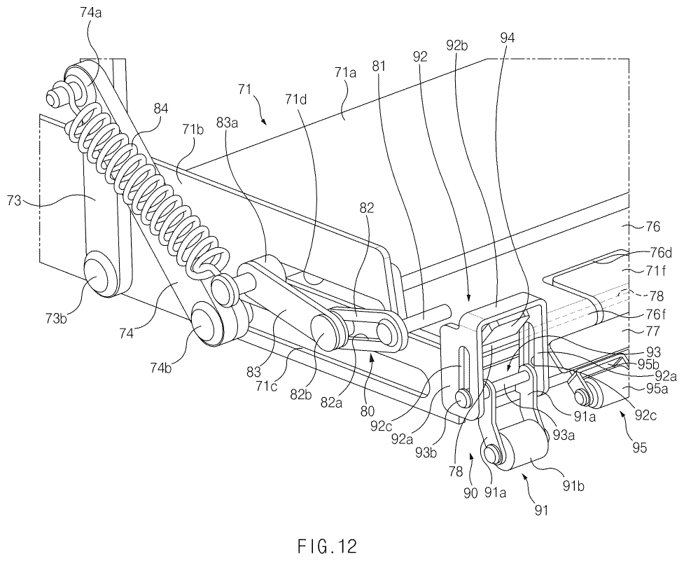

Referring to FIG. 12, each side wall 71b of the step body 71 may have a slider slot 71c and a guide slot 71d, and the slider slot 71c and the guide slot 71d may extend in the longitudinal direction of the case 11. The slider slot 71c may be located below the guide slot 71d, the slider slot 71c may be parallel to the guide slot 71d, and a length of the guide slot 71d may be less than that of the slider slot 71c.

When the step body 71 moves between the retracted position and the extended position, the plurality of step bars 72 and 73 may be configured to hold the bottom wall 71a of the step body 71 in a horizontal state. The plurality of step bars 72 and 73 may include a pair of first step bars 72 and a pair of second step bars 73 connecting both side walls 12b of the platform 12 and both side walls 71b of the step body 71. Top ends of the step bars 72 and 73 may be pivotally connected to each side wall 12b of the platform 12 through pivot pins 72a and 73a, respectively, and bottom ends of the step bars 72 and 73 may be pivotally connected to each side wall 71b of the step body 71 through pivot pins 72b and 73b, respectively.

The step device 17 may include an actuator 75 configured to move any one of the first step bar 72 and the second step bar 73. Referring to FIGS. 10 and 11, the actuator 75 may be configured to move a middle portion of the first step bar 72 forward and backward. The actuator 75 may include a motor 75a, a lead screw 75b rotated by the motor 75a, a nut 75c threadably engaged to the lead screw 75b, and a rod 75d fixed to the nut 75c. The motor 75a may be a bidirectional motor operating clockwise and counterclockwise, and the lead screw 75b may rotate around a central longitudinal axis thereof by the motor 75a. The nut 75c may move along the central longitudinal axis of the lead screw 75b by the rotation of the lead screw 75b. As the nut 75c moves along the central longitudinal axis of the lead screw 75b, the rod 75d may move together with the nut 75c in the same direction. One end of the rod 75d may be fixed to the nut 75c, and the other end of the rod 75d may be pivotally connected to the middle portion of the first step bar 72 through a pivot pin 72c.

Referring to FIG. 10, as the nut 75c and the rod 75d move backward toward the trailing portion of the platform 12 by the motor 75a, the first step bar 72 and the second step bar 73 may be inclined at a predetermined angle. Accordingly, the step body 71 may move backward and upward so as to be overlapped with the leading portion of the platform 12 (that is, the step body 71 may come into contact with or may be close to the leading portion of the platform 12) so that the step body 71 may be in the retracted position.

Referring to FIG. 11, as the nut 75c and the rod 75d move forward toward the leading portion of the platform 12 by the motor 75a, the first step bar 72 and the second step bar 73 may be vertically upright. Accordingly, the step body 71 may move forward and downward from the platform 12 so that the step body 71 may be in the extended position.

The step device 17 may further include a slider bar 74 pivotally connecting any one of the first step bar 72 and the second step bar 73 to the step body 71. Referring to FIGS. 10 and 11, the slider bar 74 may be configured to pivotally connect the second step bar 73 to the step body 71. The slider bar 74 may intersect the second step bar 73 at a predetermined angle. A top end of the slider bar 74 may be pivotally connected to a middle portion of the second step bar 73 through a pivot pin 74a, and a bottom end of the slider bar 74 may be pivotally and slidably connected to the slider slot 71c of the step body 71 through a guide pin 74b. When the step body 71 is in the horizontally extended position, the slider bar 74 may stably support a load of the step body 71.

Referring to FIGS. 10 and 11, the step device 17 may further include a safety cover 76 and a skirt 77 pivotally mounted on a leading portion of the step body 71. A bottom edge of the safety cover 76 may be pivotally mounted on the leading portion of the step body 71, and a top edge of the skirt 77 together with the bottom edge of the safety cover 76 may be pivotally connected to the leading portion of the step body 71.

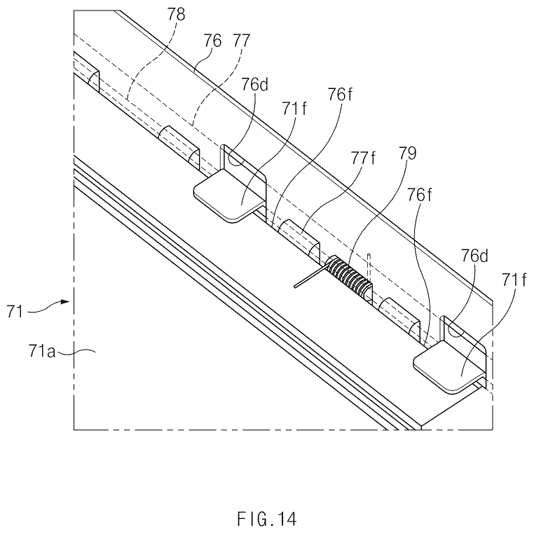

The safety cover 76 may be configured to move between a cover position (see FIG. 10) in which the safety cover 76 is vertically unfolded to cover a leading opening of the step body 71 and an uncover position (see FIGS. 11 and 12) in which the safety cover 76 is horizontally folded toward the bottom wall 71a of the step body 71 to uncover the leading opening of the step body 71. Referring to FIG. 14, a plurality of biasing members 79 may be mounted on a hinge shaft 78, and each biasing member 79 may be a torsion spring or the like. The safety cover 76 may be biased to the cover position by the biasing members 79. When a force greater than a biasing force of the biasing member 79 is applied to the safety cover 76, the safety cover 76 may move to the uncover position. Referring to FIG. 10, when the step body 71 is in the retracted position, the safety cover 76 may be in the cover position, and accordingly the safety cover 76 may cover the leading opening of the step body 71. Referring to FIG. 11, when the step body 71 is in the extended position, the safety cover 76 may be in the uncover position, and accordingly the safety cover 76 may uncover the leading opening of the step body 71. In addition, when a passenger steps on the safety cover 76 during the ingress and egress of the passenger, the safety cover 76 may be folded toward the step body 71 or may be folded outside the step body 71. That is, the safety cover 76 may be manually moved to the uncover position to uncover the leading opening of the step body 71.

Referring to FIGS. 11 and 14, the bottom edge of the safety cover 76 and the top edge of the skirt 77 may be pivotally connected to the bottom wall 71a of the step body 71 through the hinge shaft 78. The hinge shaft 78 may extend along the bottom edge of the safety cover 76. The bottom wall 71a of the step body 71 may have a plurality of hinge lugs 71f provided at the leading portion thereof, the safety cover 76 may have a plurality of hinge lugs 76f provided at the bottom edge thereof, and the skirt 77 may have a plurality of hinge lugs 77f provided at the top edge thereof. The hinge lugs 71f of the step body 71, the hinge lugs 76f of the safety cover 76, and the hinge lugs 77f of the skirt 77 may be arranged alternately, and the hinge shaft 78 may extend through the hinge lugs 71f of the step body 71, the hinge lugs 76f of the safety cover 76, and the hinge lugs 77f of the skirt 77 so that the safety cover 76 and the skirt 77 may pivot around the hinge shaft 78.

Referring to FIGS. 11, 12, and 14, the safety cover 76 may have a plurality of notches 76d corresponding to the hinge lugs 71f of the step body 71, respectively. Referring to FIG. 12, when the safety cover 76 moves to the uncover position around the hinge shaft 78, the hinge lugs 71f of the step body 71 may be inserted into the notches 76d of the safety cover 76.

The step device 17 may further include a pair of link mechanisms 80 each operably connecting the safety cover 76 to any one of the first step bar 72 and the second step bar 73. Referring to FIGS. 10 and 11, the pair of link mechanisms 80 may be configured to operably connect the safety cover 76 to the second step bar 73.

Each link mechanism 80 may include a cover pin 81 connected to the safety cover 76, a first link 82 pivotally connected to the cover pin 81, a second link 83 pivotally connected to the first link 82, and a spring 84 elastically connecting the second link 83 and the second step bar 73.

The cover pin 81 may be offset from the hinge shaft 78 of the safety cover 76. The cover pin 81 may be parallel to the hinge shaft 78 of the safety cover 76. The cover pin 81 may be fixed to an exterior surface of the safety cover 76 so that the cover pin 81 may be integrally connected to the safety cover 76, and accordingly the cover pin 81 and the safety cover 76 may move together.

One end of the first link 82 may be pivotally connected to the second link 83 through a pivot pin 82b, and the other end of the first link 82 may be pivotally connected to the cover pin 81. The first link 82 may have a slot 82a defined therein, and the cover pin 81 and the pivot pin 82b may be inserted into the slot 82a of the first link 82.

One end of the second link 83 may be pivotally and slidably connected to the guide slot 71d of the step body 71 through a guide pin 83a, and the other end of the second link 83 may be pivotally connected to one end of the first link 82 through the pivot pin 82b.

The spring 84 may be a compression coil spring. One end of the spring 84 may be connected to the second step bar 73, and the other end of the spring 84 may be connected to the second link 83. Specifically, one end of the spring 84 may be connected to a pivot pin 74a connecting the second step bar 73 and the slider bar 74, and the other end of the spring 84 may be connected to the guide pin 83a of the second link 83.

Accordingly, the cover pin 81 may be integrally connected to the safety cover 76, and the spring 84 may be provided to elastically connect the second step bar 73 and the second link 83 so that the safety cover 76 may be operably connected to the link mechanism 80 and the second step bar 73.

Referring to FIG. 10, when the step body 71 moves to the retracted position, the first step bar 72 and the second step bar 73 may be inclined at a predetermined angle, the second link 83 may move forward along the guide slot 71d, the spring 84 may be compressed, and the first link 82 may be vertically upright so that the cover pin 81 may be offset vertically upward from the hinge shaft 78 of the safety cover 76. Since a force applied to the safety cover 76 by the cover pin 81 is less than the biasing force of the biasing member 79, the safety cover 76 may be vertically unfolded by the biasing force of the biasing member 79, and the safety cover 76 may be in the cover position.

Referring to FIG. 11, when the step body 71 moves to the extended position, the first step bar 72 and the second step bar 73 may be vertically upright, the second link 83 may move backward along the guide slot 71d, the spring 84 may be extended, and the first link 82 may be horizontally folded so that the cover pin 81 may be offset from the hinge shaft 78 of the safety cover 76 toward the platform 12. Referring to FIGS. 11 and 12, the cover pin 81 may push the safety cover 76 toward the bottom wall 71a of the step body 71 so that the safety cover 76 may be horizontally folded toward the bottom wall 71a of the step body 71, and the safety cover 76 may be in the uncover position.

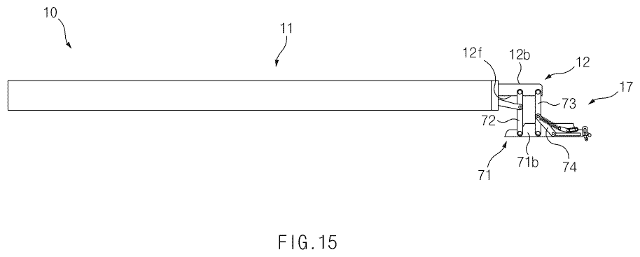

When the leading portion of the platform 12 and the step body 71 are deployed and extended from the case 11, the step body 71 of the step device 17 may operate in a step mode by the actuator 75 and the plurality of step bars 72 and 73. The step mode refers to a mode in which the step body 71 moves between the retracted position (see FIG. 10) and the extended position (see FIG. 11). Referring to FIG. 15, when the leading portion of the platform 12 and the step body 71 are deployed from the case 11, the step body 71 of the step device 17 may move to the extended position by the actuator 75 and the step bars 72 and 73, and the safety cover 76 may move to the uncover position by the link mechanisms 80. In a state in which the step body 71 is in the extended position and the safety cover 76 moves to the uncover position, the ingress and egress of an ordinary passenger without disabilities may be eased through the step body 71.

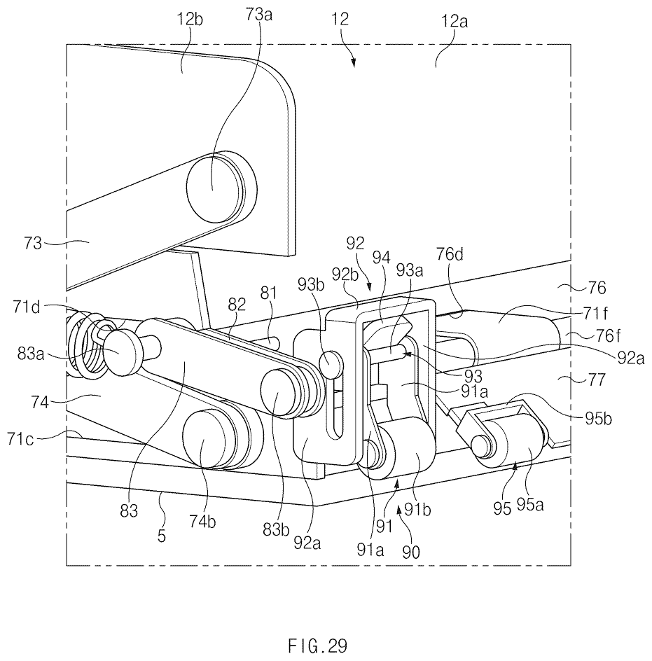

Referring to FIG. 29, when the step body 71 is close to the ground, a bottom edge of the skirt 77 may come into contact with the ground so that the skirt 77 may bridge a height difference between the step body 71 and the ground, making the ingress and egress of various types of passengers easier.

Referring to FIGS. 3 to 5, the platform 12 may be connected to the shaft 61 through a plurality of lift bars 65 and 66 and a pair of bracket assemblies 50.

Referring to FIG. 16, the plurality of lift bars 65 and 66 may include a pair of first lift bars 65 and a pair of second lift bars 66 disposed on both side walls 12b of the platform 12 and both ends of the shaft 61.

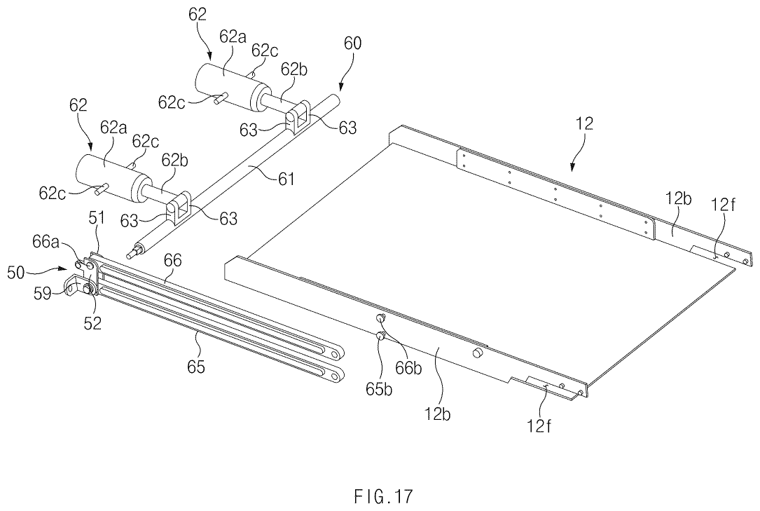

Referring to FIG. 17, each first lift bar 65 may extend to be parallel to the corresponding second lift bar 66, and each second lift bar 66 may be located above the corresponding first lift bar 65. One end of the first lift bar 65 may be connected to the shaft 61 through a connector 67, and the other end of the first lift bar 65 may be pivotally connected to the corresponding side wall 12b of the platform 12 through a pivot pin 65b. One end of the first lift bar 65 may be rotatably supported to the bracket assembly 50. One end of the second lift bar 66 may be pivotally connected to the bracket assembly 50 through a pivot pin 66a, and the other end of the second lift bar 66 may be pivotally connected to the corresponding side wall 12b of the platform 12 through a pivot pin 66b.

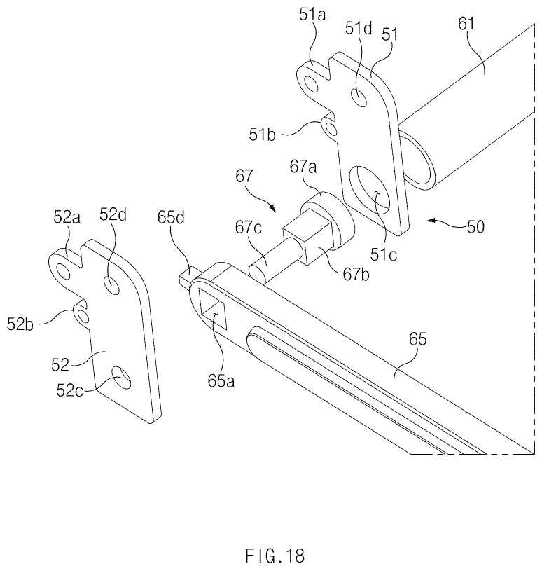

Referring to FIG. 18, each first lift bar 65 may have a rectangular hole 65a.

The connector 67 may be fixed to each end of the shaft 61. Referring to FIG. 18, the connector 67 may include a fixed portion 67a fixed to the end of the shaft 61, an insert portion 67b protruding from the fixed portion 67a, and a stud portion 67c protruding from the insert portion 67b. The fixed portion 67a may have a cylindrical shape, and the insert portion 67b may have a rectangular cuboid shape. The stud portion 67c may have external threads formed on at least a portion of an exterior surface thereof. The insert portion 67b of the connector 67 may be fitted into the hole 65a of the first lift bar 65 so that the connector 67 may be fixed to the first lift bar 65. Accordingly, each first lift bar 65 may be fixed to the corresponding end of the shaft 61 through the connector 67 so that the first lift bar 65 may rotate together with the shaft 61 in the same direction.

The pair of bracket assemblies 50 may be disposed on both ends of the shaft 61, and one end of the first lift bar 65 and one end of the corresponding second lift bar 66 may be connected to the corresponding bracket assembly 50.

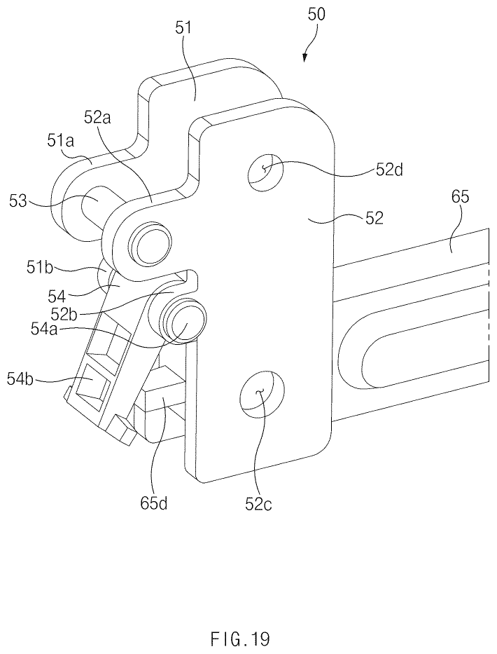

Referring to FIGS. 18 and 19, each bracket assembly 50 may include a first bracket 51 adjacent to the corresponding end of the shaft 61 and a second bracket 52 spaced apart from the first bracket 51. The second bracket 52 may be located farther from the end of the shaft 61 than the first bracket 51. The first bracket 51 may have a mounting lug 51a protruding from an upper portion thereof and a pivot lug 51b protruding from a lower portion thereof. The second bracket 52 may have a mounting lug 52a protruding from an upper portion thereof and a pivot lug 52b protruding from a lower portion thereof. The mounting lug 51a of the first bracket 51 and the mounting lug 52a of the second bracket 52 may be located above the first lift bar 65.

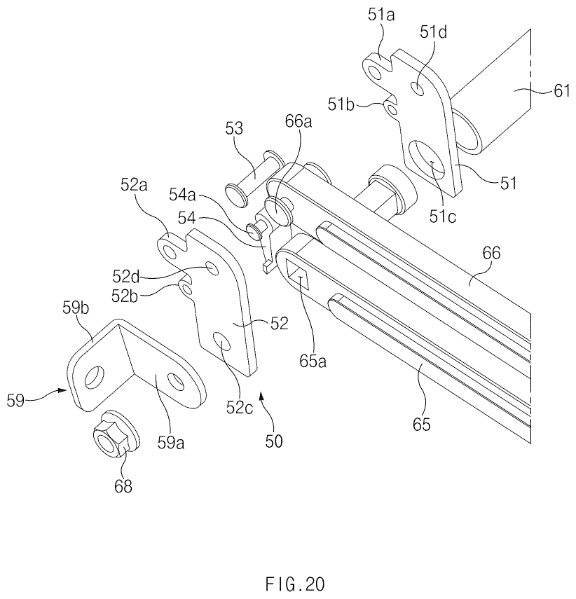

The bracket assembly 50 may include a striker pin 53 connecting the first bracket 51 and the second bracket 52. The striker pin 53 may extend transverse to the first bracket 51 and the second bracket 52. Referring to FIG. 20, the striker pin 53 may be mounted on the mounting lug 51a of the first bracket 51 and the mounting lug 52a of the second bracket 52, and accordingly the first bracket 51 and the second bracket 52 may be connected to each other through the striker pin 53. The striker pin 53 may be located on the upper portion of the bracket assembly 50, and the striker pin 53 may be located above the first lift bar 65.

The bracket assembly 50 may include a lock member 54 configured to lock and unlock the first lift bar 65 to the bracket assembly 50. The lock member 54 may be configured to move between a lock position in which the lock member 54 locks the first lift bar 65 to the bracket assembly 50 and an unlock position in which the lock member 54 unlocks the first lift bar 65 from the bracket assembly 50. Referring to FIG. 19, an upper portion of the lock member 54 may be pivotally mounted on the pivot lug 51b of the first bracket 51 and the pivot lug 52b of the second bracket 52 through a pivot pin 54a. The lock member 54 may be biased to the lock position by a biasing member such as a torsion spring. When a force is not applied to the lock member 54, the lock member 54 may lock the first lift bar 65 to the bracket assembly 50 by the biasing member.

Referring to FIG. 19, each first lift bar 65 may have a locking projection 65d protruding toward the lock member 54, and the lock member 54 may have a locking hole 54b provided in a lower portion thereof. As the lock member 54 pivots around the pivot pin 54a, the locking projection 65d of the first lift bar 65 may be engaged to and disengaged from the locking hole 54b of the lock member 54. As the lock member 54 pivots toward the first lift bar 65, the lock member 54 may be in the lock position, and accordingly the locking hole 54b of the lock member 54 and the locking projection 65d of the first lift bar 65 may be engaged so that the first lift bar 65 may be locked to the bracket assembly 50. As the lock member 54 pivots away from the first lift bar 65, the lock member 54 may be in the unlock position, and accordingly the locking hole 54b of the lock member 54 and the locking projection 65d of the first lift bar 65 may be disengaged so that the first lift bar 65 may be unlocked from the bracket assembly 50.

Referring to FIG. 18, the first bracket 51 may have a lower hole 51c formed in the lower portion thereof and an upper hole 51d formed in the upper portion thereof, and the second bracket 52 may have a lower hole 52c formed in the lower portion thereof and an upper hole 52d formed in the upper portion thereof. A diameter of the lower hole 51c of the first bracket 51 may correspond to an outer diameter of the fixed portion 67a of the connector 67, and a diameter of the lower hole 52c of the second bracket 52 may correspond to an outer diameter of the stud portion 67c of the connector 67.

Referring to FIG. 20, one end of the first lift bar 65 may be interposed between the first bracket 51 and the second bracket 52, the fixed portion 67a of the connector 67 may pass through the lower hole 51c of the first bracket 51, the stud portion 67c of the connector 67 may extend through the lower hole 52c of the second bracket 52, and a nut 68 may be screwed to the stud portion 67c of the connector 67 on an exterior surface of the second bracket 52 so that the connector 67 may be rotatably supported to the first bracket 51 and the second bracket 52 of the bracket assembly 50.

Referring to FIG. 20, one end of the second lift bar 66 may be interposed between the first bracket 51 and the second bracket 52, and one end of the second lift bar 66 may be mounted in the upper hole 51d of the first bracket 51 and the upper hole 52d of the second bracket 52 through the pivot pin 66a.

The bracket assembly 50 and the connector 67 may be connected to the moving body 13 through a mounting member 59. Referring to FIG. 20, the mounting member 59 may have a first mounting portion 59a connected to the connector 67 and the bracket assembly 50 and a second mounting portion 59b fixed to the moving body 13. The first mounting portion 59a and the second mounting portion 59b may be perpendicular to each other so that the mounting member 59 may have an L-shaped cross section. The stud portion 67c of the connector 67 may extend through a hole of the first mounting portion 59a of the mounting member 59, and the nut 68 may be screwed to the stud portion 67c of the connector 67 so that the connector 67 and the second bracket 52 of the bracket assembly 50 may be connected to the first mounting portion 59a of the mounting member 59. The second mounting portion 59b of the mounting member 59 may be fixed to the moving body 13 using a bolt and/or the like.

The passenger ingress and egress assistance apparatus 10 according to an exemplary embodiment of the present disclosure may include a pair of clutch devices 40 configured to lock and unlock the pair of bracket assemblies 50 to the moving body 13, respectively. The pair of clutch devices 40 may be mounted on the moving body 13, and each clutch device 40 may lock and unlock the corresponding bracket assembly 50 to the moving body 13.

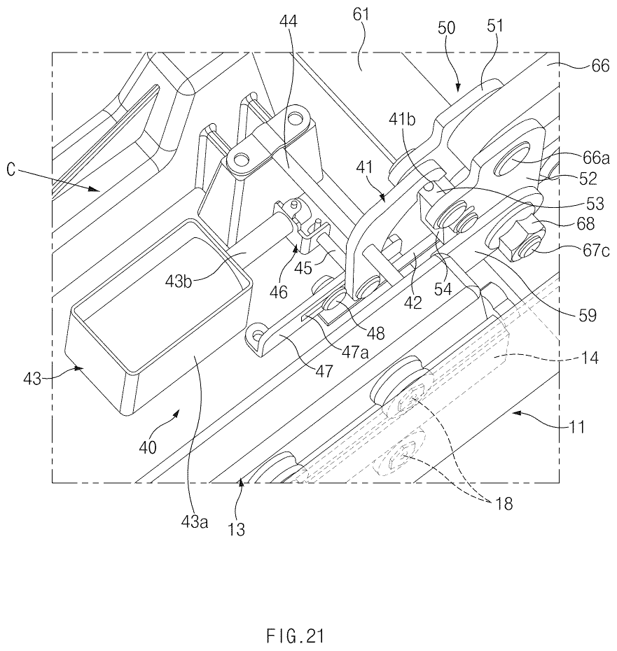

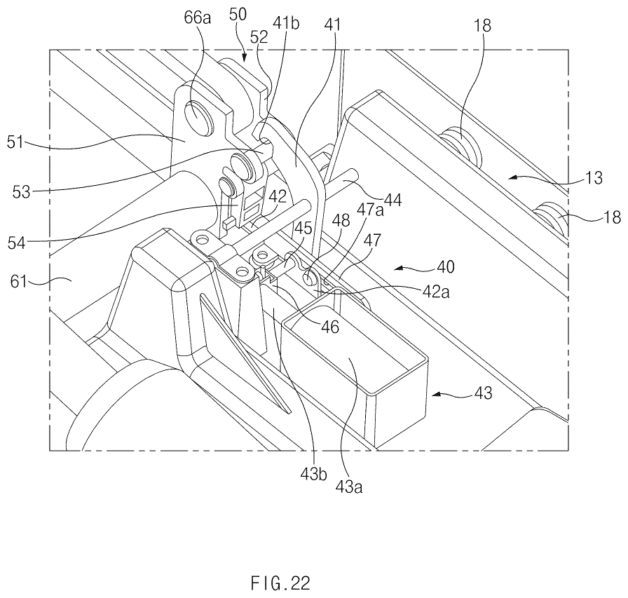

Referring to FIGS. 21, 22, and 23, the clutch device 40 may include a clutch member 41 configured to engage and disengage the striker pin 53 of the bracket assembly 50, a release member 42 configured to move the lock member 54 to the unlock position, and an actuator 43 driving the clutch member 41 and the release member 42.

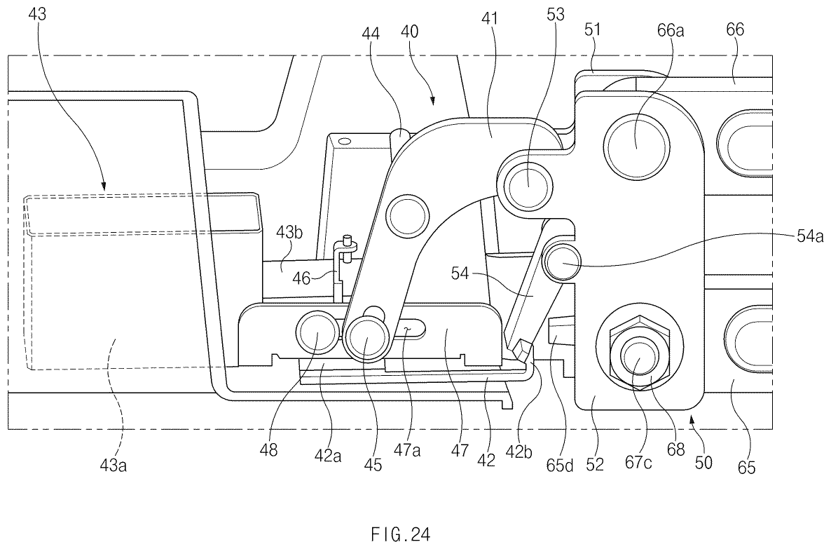

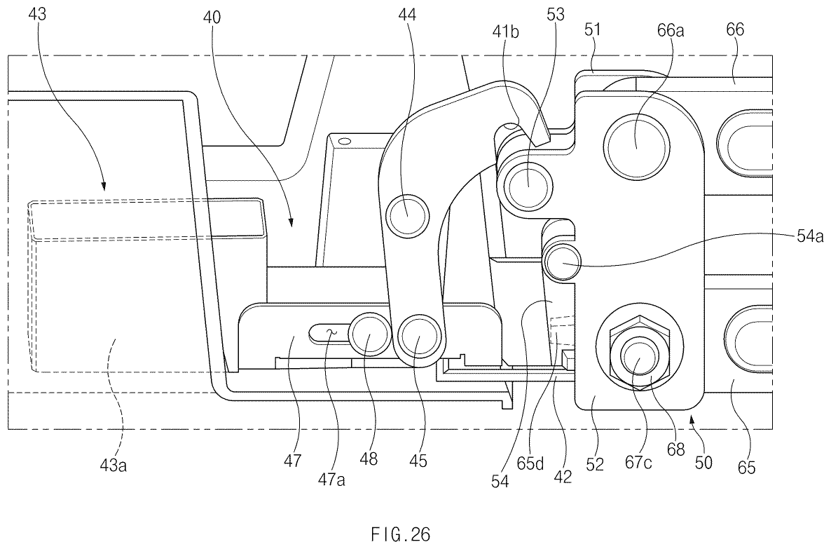

The clutch member 41 may be configured to move between an engaging position (see FIG. 24) in which the clutch member 41 engages the striker pin 53 of the bracket assembly 50 and a disengaging position (see FIG. 26) in which the clutch member 41 disengages the striker pin 53 of the bracket assembly 50. A clutch shaft 44 may be mounted on the moving body 13, and the clutch member 41 may have a shaft hole 41a formed in a middle portion thereof. The clutch shaft 44 may extend through the shaft hole 41a of the clutch member 41, and the clutch member 41 may pivot around the clutch shaft 44. The clutch member 41 may have an opening 41b formed in an upper portion thereof, and the clutch member 41 may be configured to pivot above the striker pin 53. When the clutch member 41 is in the engaging position, the opening 41b of the clutch member 41 may receive the striker pin 53 of the bracket assembly 50. When the clutch member 41 is in the disengaging position, the striker pin 53 of the bracket assembly 50 may be disengaged from the opening 41b of the clutch member 41.

The actuator 43 may be a solenoid mechanism including a housing 43a having a coil embedded therein and a plunger 43b moving forward and backward with respect to the housing 43a.

The clutch member 41 may be connected to the plunger 43b of the actuator 43 through a connection pin 45. The clutch member 41 may have a through hole 41c formed in a lower portion thereof. One end of the connection pin 45 may be connected to the through hole 41c of the clutch member 41, and the other end of the connection pin 45 may be connected to an end of the plunger 43b through a plunger connector 46. As the plunger 43b moves forward and backward, the lower portion of the clutch member 41 may move forward and backward in the same direction as the movement of the plunger 43b, and accordingly the clutch member 41 may pivot around the clutch shaft 44. Referring to FIG. 24, as the plunger 43b of the actuator 43 moves backward away from the bracket assembly 50, the lower portion of the clutch member 41 may move backward, and accordingly the upper portion of the clutch member 41 may pivot toward the bracket assembly 50 around the clutch shaft 44. Referring to FIG. 26, as the plunger 43b of the actuator 43 moves forward toward the bracket assembly 50, the lower portion of the clutch member 41 may move forward, and accordingly the upper portion of the clutch member 41 may pivot away from the bracket assembly 50 around the clutch shaft 44.

The release member 42 may extend in the longitudinal direction of the case 11. The release member 42 together with the lower portion of the clutch member 41 may be connected to the plunger 43b of the actuator 43, and accordingly the release member 42 may move in the same direction with the lower portion of the clutch member 41 by the actuator 43. The release member 42 may have a mounting lug 42a provided on one end thereof, and the mounting lug 42a may have a through hole 42c. The connection pin 45 may extend through the through hole 41c of the clutch member 41 and the through hole 42c of the mounting lug 42a of the release member 42 so that the release member 42 together with the lower portion of the clutch member 41 may be connected to the plunger 43b of the actuator 43 through the connection pin 45 and the plunger connector 46. Accordingly, as the plunger 43b of the actuator 43 moves backward away from the bracket assembly 50, the release member 42 may move backward together with the lower portion of the clutch member 41 (see FIG. 24), and as the plunger 43b of the actuator 43 moves forward toward the platform 12, the release member 42 may move forward together with the lower portion of the clutch member 41 (see FIG. 26).

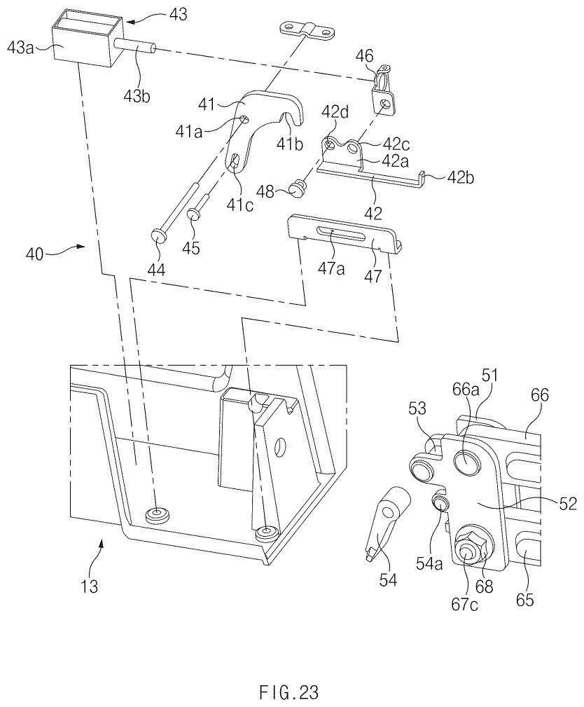

Referring to FIG. 23, the clutch device 40 may further include a guide plate 47 guiding the movement of the release member 42, and the guide plate 47 may be fixed to the moving body 13. The guide plate 47 may have a guide slot 47a extending in a longitudinal direction of the release member 42. The release member 42 may have a guide pin 48 fixed to the mounting lug 42a. The mounting lug 42a of the release member 42 may have a mounting hole 42d, and the guide pin 48 may be fixed to the mounting hole 42d of the mounting lug 42a. The guide pin 48 of the release member 42 may be guided along the guide slot 47a of the guide plate 47.

Referring to FIG. 23, the release member 42 may have a tip 42b engaging and disengaging a bottom end of the lock member 54. The tip 42b may protrude upward from the other end of the release member 42.

Referring to FIG. 24, as the release member 42 moves backward away from the bracket assembly 50, the tip 42b of the release member 42 may engage the bottom end of the lock member 54, and accordingly the lock member 54 may be pulled toward the moving body 13 by the release member 42. Since a force applied to the lock member 54 is greater than a biasing force of the biasing member, the lock member 54 may move to the unlock position.

Referring to FIG. 26, as the release member 42 moves forward toward the platform 12 by the actuator 43, the tip 42b of the release member 42 may release the bottom end of the lock member 54. Accordingly, since a force is not applied to the lock member 54, the lock member 54 may move to the lock position by the biasing member.

Referring to FIG. 24, as the plunger 43b of the actuator 43 moves backward away from the bracket assembly 50, the lower portion of the clutch member 41 and the release member 42 may move backward away from the bracket assembly 50. As the lower portion of the clutch member 41 moves backward, the clutch member 41 may pivot toward the bracket assembly 50 around the clutch shaft 44 so that the clutch member 41 may be in the engaging position, and the opening 41b of the clutch member 41 may receive the striker pin 53 of the bracket assembly 50. Accordingly, the clutch member 41 may engage the striker pin 53 of the bracket assembly 50 so that the bracket assembly 50 may be locked to the moving body 13. As the release member 42 moves backward away from the bracket assembly 50, the tip 42b of the release member 42 may engage the bottom end of the lock member 54, and accordingly the lock member 54 may be pulled toward the moving body 13 by the release member 42. Since the force applied to the lock member 54 is greater than the biasing force of the biasing member, the lock member 54 may move to the unlock position. When the lock member 54 is in the unlock position, the first lift bar 65 may be unlocked from the bracket assembly 50.

As described above, the clutch member 41 may engage the striker pin 53 of the bracket assembly 50 so that the bracket assembly 50 may be locked to the moving body 13, and the lock member 54 may be in the unlock position so that the first lift bar 65 may be unlocked from the bracket assembly 50. Accordingly, one end of the first lift bar 65 and one end of the second lift bar 66 may be free to rotate with respect to the bracket assembly 50 locked to the moving body 13, and the other end of the first lift bar 65 and the other end of the second lift bar 66 may be free to rotate with respect to the platform 12. In this state, as the first lift bar 65 and the second lift bar 66 pivot with respect to the bracket assembly 50 in the same direction as the rotation direction of the shaft 61, the passenger ingress and egress assistance apparatus 10 according to an exemplary embodiment of the present disclosure may operate in a lift mode.

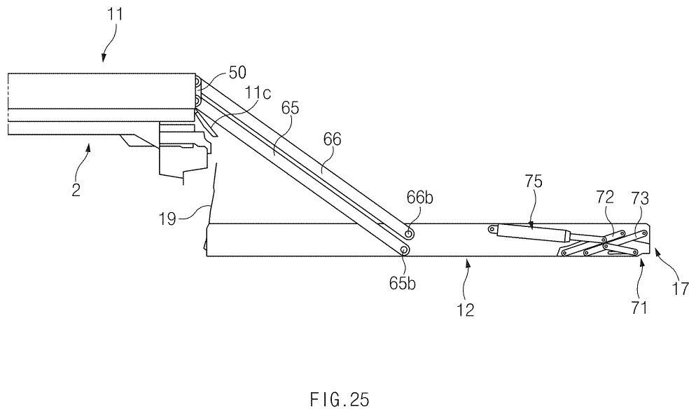

The lift mode refers to a mode in which the platform 12 moves between the deployed position (see FIG. 9) and a downward horizontal position (see FIG. 25) by the actuator 62 of the hinge mechanism 16, the first lift bar 65, and the second lift bar 66 in a state in which the platform 12 is fully deployed from the cavity of the case 11 by the driver 15. Referring to FIG. 9, the deployed position refers to a position in which the platform 12 is horizontally aligned with the cavity of the case 11. Referring to FIG. 25, the downward horizontal position refers to a position in which the platform 12 is horizontal below the cavity of the case 11, and the platform 12 may come into contact with or may be close to the ground when the platform 12 is in the downward horizontal position.

Referring to FIG. 25, in a state in which the bracket assembly 50 is locked to the moving body 13 by the clutch device 40, as the shaft 61 rotates clockwise by the actuator 62 of the hinge mechanism 16, the first lift bar 65 and the second lift bar 66 may pivot clockwise and downward with respect to the bracket assembly 50, and accordingly the platform 12 held in the horizontal state may move to the downward horizontal position.

In a state in which the bracket assembly 50 is locked to the moving body 13 by the clutch device 40, as the shaft 61 rotates counterclockwise by the actuator 62 of the hinge mechanism 16, the first lift bar 65 and the second lift bar 66 may pivot counterclockwise and upward with respect to the bracket assembly 50, and accordingly the platform 12 held in the horizontal state may move from the downward horizontal position (see FIG. 25) to the deployed position (see FIG. 9).

Referring to FIG. 26, as the plunger 43b of the actuator 43 moves forward toward the bracket assembly 50, the lower portion of the clutch member 41 and the release member 42 may move forward toward the bracket assembly 50. As the lower portion of the clutch member 41 moves forward, the clutch member 41 may pivot away from the bracket assembly 50 so that the clutch member 41 may be in the disengaging position, and the striker pin 53 of the bracket assembly 50 may be disengaged from the opening 41b of the clutch member 41. Accordingly, the clutch member 41 may disengage the striker pin 53 of the bracket assembly 50 so that the bracket assembly 50 may be unlocked from the moving body 13. As the release member 42 moves forward toward the platform 12, the tip 42b of the release member 42 may release the bottom end of the lock member 54. Accordingly, since the force is not applied to the lock member 54, the lock member 54 may move to the lock position by the biasing member. When the lock member 54 is in the lock position, the first lift bar 65 may be locked to the bracket assembly 50.

As described above, the clutch member 41 may disengage the striker pin 53 of the bracket assembly 50 so that the bracket assembly 50 may be unlocked from the moving body 13. As the lock member 54 is in the unlock position, the first lift bar 65 may be unlocked from the bracket assembly 50. Accordingly, as the bracket assembly 50 becomes rotatable around the shaft 61, the bracket assembly 50 may rotate in the same direction as the rotation direction of the shaft 61 by the rotation of the shaft 61, and the first lift bar 65 and the second lift bar 66 may move together with the bracket assembly 50. The platform 12 may be restrained from pivoting with respect to the first lift bar 65 and the second lift bar 66, and the passenger ingress and egress assistance apparatus 10 may operate in a slope mode through the bracket assembly 50, the first lift bar 65, and the second lift bar 66.

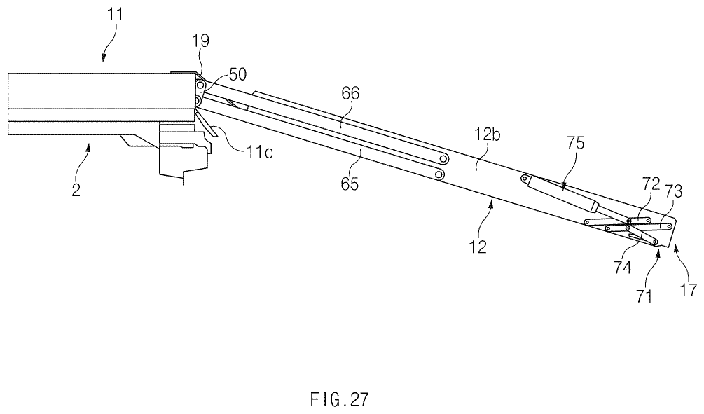

The slope mode refers to a mode in which the platform 12 moves between the deployed position (see FIG. 9) and an inclined position (see FIG. 27) by the actuator 62 of the hinge mechanism 16 in a state in which the platform 12 is fully deployed from the cavity of the case 11 by the driver 15. Referring to FIG. 27, the inclined position refers to a position in which the platform 12 is inclined with respect to the case 11 at a predetermined angle.

Referring to FIG. 27, as the shaft 61 rotates clockwise by the actuator 62 of the hinge mechanism 16, the bracket assembly 50, the first lift bar 65, and the second lift bar 66 may rotate clockwise and downward, and accordingly the platform 12 together with the first lift bar 65 and the second lift bar 66 may move to the inclined position at a predetermined angle.

As the shaft 61 rotates counterclockwise by the actuator 62 of the hinge mechanism 16, the bracket assembly 50, the first lift bar 65, and the second lift bar 66 may rotate counterclockwise and upward, and accordingly the platform 12 may move from the inclined position (see FIG. 27) to the deployed position (see FIG. 9).

As described above, the clutch device 40 may lock and unlock the bracket assembly 50 to the moving body 13 and simultaneously unlock and lock the first lift bar 65 to the bracket assembly 50 so that the passenger ingress and egress assistance apparatus 10 may operate in at least one of the lift mode and the slope mode by the actuator 62 of the hinge mechanism 16. When the passenger ingress and egress assistance apparatus 10 operates in the lift mode, the ingress and egress of a passenger using a wheelchair may be eased. When the passenger ingress and egress assistance apparatus 10 operates in the slope mode, the ingress and egress of a passenger using a bicycle, a stroller, or a hand carrier may be eased.

When the step body 71 of the step device 17 moves to the extended position in the step mode, the safety cover 76 may move to the uncover position by the link mechanism 80. When the platform 12 moves to the downward horizontal position (see FIG. 25) in the lift mode or moves to the inclined position (see FIG. 27) in the slope mode, the step body 71 of the step device 17 may be in the retracted position to be overlapped with the leading portion of the platform 12, and accordingly the safety cover 76 may not be allowed to move to the uncover position by the actuator 75 and the link mechanism 80. In a state in which the step body 71 is in the retracted position to be overlapped with the leading portion of the platform 12, when the platform 12 is in the downward horizontal position in the lift mode or is in the inclined position in the slope mode (that is, when the step body 71 comes into contact with or is close to the ground), it may be necessary to move the safety cover 76 to the uncover position so as to facilitate the ingress and egress of various types of passengers.

The passenger ingress and egress assistance apparatus 10 according to an exemplary embodiment of the present disclosure may further include a pair of moving mechanisms 90 configured to move the safety cover 76 to the uncover position when the platform 12 comes into contact with or is close to the ground in a state in which the step body 71 of the step device 17 is in the retracted position to be overlapped with the leading portion of the platform 12. The pair of moving mechanisms 90 may be mounted on the pair of side walls 71b of the step body 71, respectively. The safety cover 76 may further include a pair of guide projections 94 protruding from both ends of the bottom edge thereof, respectively. Each guide projection 94 may extend in a direction inclined with respect to the safety cover 76 at a predetermined angle. Each moving mechanism 90 may cooperate with the corresponding guide projection 94 to move the safety cover 76 to the uncover position.

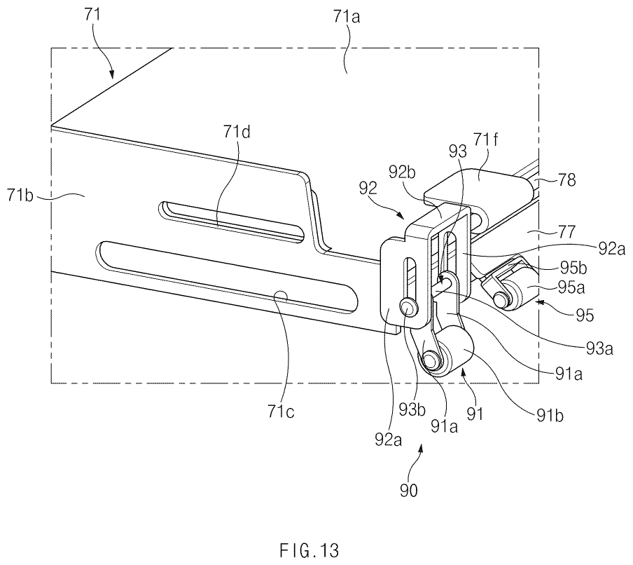

Referring to FIGS. 12, 13, 28, and 29, each moving mechanism 90 may include a wheel assembly 91 moving upward and downward and a guide bracket 92 guiding the upward and downward movement of the wheel assembly 91.

The wheel assembly 91 may be configured to move upward and downward as it comes into contact with or is spaced apart from the ground. The wheel assembly 91 may include a pair of legs 91a spaced apart from each other, a wheel 91b rotatably mounted between bottom ends of the pair of legs 91a, and a guide pin 93 mounted between top ends of the pair of legs 91a. Each leg 91a may extend vertically, and the pair of legs 91a may be parallel to each other. When the platform 12 comes into contact with or is close to the ground, the wheel 91b may be in rolling contact with the ground. The guide pin 93 may include a pin body 93a and a pair of heads 93b provided on both ends of the pin body 93a.

The guide bracket 92 may be fixed to the side wall 71b of the step body 71. The guide bracket 92 may include a pair of side walls 92a spaced apart from each other and a top wall 92b connecting top ends of the pair of side walls 92a. Each side wall 92a may extend vertically, and the pair of side walls 92a may be parallel to each other. Each side wall 92a may have a guide slot 92c extending vertically.

The legs 91a of the wheel assembly 91 may be located between the side walls 92a of the guide bracket 92, and the guide pin 93 of the wheel assembly 91 may move along the guide slot 92c of the guide bracket 92 so that the vertical movement of the wheel assembly 91 may be guided by the guide bracket 92.

The wheel assembly 91 may be configured to move between an upward position in which the guide pin 93 pushes the guide projection 94 and a downward position in which the guide pin 93 is spaced apart downward from the guide projection 94. When the platform 12 is close to the ground, the wheel 91b of the wheel assembly 91 may be in rolling contact with the ground so that the wheel assembly 91 may move upward along the guide bracket 92, and the pin body 93a of the guide pin 93 may push the guide projection 94 of the safety cover 76 so that the safety cover 76 may move to the uncover position. When the wheel 91b of the wheel assembly 91 is spaced apart from the ground, the wheel assembly 91 may move downward along the guide bracket 92, and the pin body 93a of the guide pin 93 may be spaced apart downward from the guide projection 94 of the safety cover 76 so that the safety cover 76 may move to the cover position by the biasing member 79.

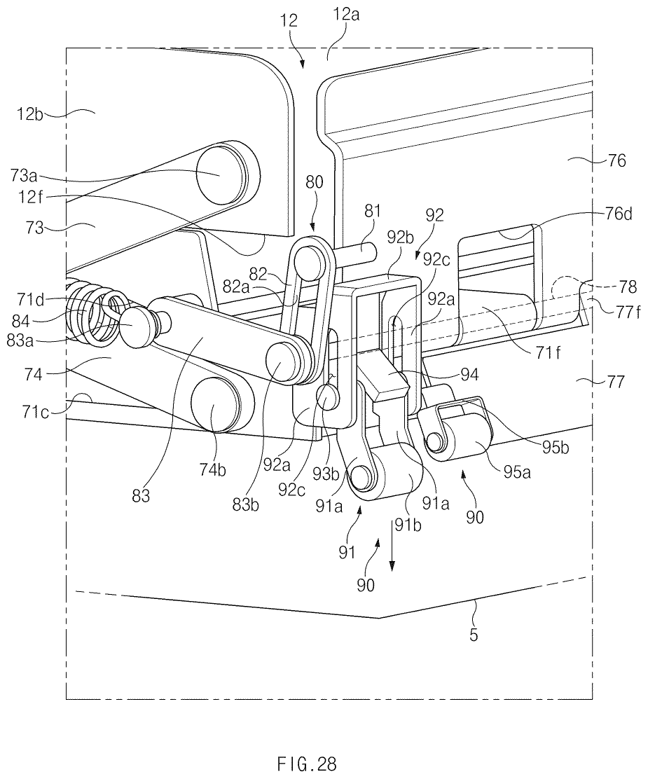

Referring to FIG. 28, when the step body 71 of the step device 17 is spaced apart from the ground in a state in which the step body 71 is in the retracted position to be overlapped with the leading portion of the platform 12, the wheel 91b of the wheel assembly 91 may not contact the ground, the guide pin 93 of the wheel assembly 91 may be located at a bottom end of the guide slot 92c of the guide bracket 92, and the safety cover 76 may be biased to the cover position by the biasing member 79.

Referring to FIG. 29, when the step body 71 of the step device 17 is in the retracted position to be overlapped with the leading portion of the platform 12 and the platform 12 is in the downward horizontal position (see FIG. 25) in the lift mode or is in the inclined position (see FIG. 27) in the slope mode, the step body 71 may be close to the ground. When the step body 71 is close to the ground, the wheel 91b of the wheel assembly 91 may be in rolling contact with the ground, and the guide pin 93 of the wheel assembly 91 may move upward to a top end of the guide slot 92c of the guide bracket 92. As the pin body 93a of the guide pin 93 moving upward pushes the guide projection 94 of the safety cover 76 upward, the safety cover 76 may move to the uncover position in which the safety cover 76 is horizontally folded toward the bottom wall 71a of the step body 71, the cover pin 81 may move with the safety cover 76 in the same direction, and the first link 82 of the link mechanism 80 together with the safety cover 76 may be horizontally folded toward the bottom wall 71a of the step body 71.

Referring to FIGS. 12, 13, 28, and 29, the skirt 77 may further include a roller device 95 provided at the bottom edge thereof. The roller device 95 may include a bracket 95b fixed to the bottom edge of the skirt 77 and a roller 95a rotatably mounted on the bracket 95b. When the step body 71 is close to the ground in the step mode, the lift mode, and the slope mode, the skirt 77 may first come into contact with the ground. As the roller 95a of the roller device 95 comes into rolling contact with the ground, it may reduce a friction between the skirt 77 and the ground and act as a buffer for the skirt 77.

As set forth above, the passenger ingress and egress assistance apparatus according to exemplary embodiments of the present disclosure may be designed to operate in various modes such as the slope mode, the lift mode, and the step mode to thereby comprehensively assist in the ingress and egress of various types of passengers such as ordinary passengers and passengers with disabilities. In particular, the platform may be stably deployed from the case in the slope mode and the lift mode, and the step body may be stably extended from the platform in the step mode so that the passenger ingress and egress assistance apparatus may provide various conveniences in the ingress and egress of various types of passengers according to the specifications of the vehicle, the surrounding environment and circumstances, and the passengers' needs.

According to exemplary embodiments of the present disclosure, the safety cover may be configured to cover and uncover the leading opening of the step body by the actuator or manually so that the ingress and egress of passengers may be eased. In particular, when the step body is overlapped with the platform, the safety cover may cover the leading opening of the step body, thereby preventing the wheelchair from falling.

According to exemplary embodiments of the present disclosure, when the step body is close to the ground, the bottom edge of the skirt may come into contact with the ground so that the skirt may bridge a height difference between the step body and the ground, making the ingress and egress of various types of passengers easier.

According to exemplary embodiments of the present disclosure, the clutch device may be configured to lock and unlock the bracket assembly and unlock and lock the first lift bar using one actuator so that the operating system thereof may be very simplified.

According to exemplary embodiments of the present disclosure, the platform, the hinge mechanism, the moving body, and the driver may be provided in the cavity of the case so that the passenger ingress and egress assistance apparatus may have a compact structure. Accordingly, the passenger ingress and egress assistance apparatus may be interchangeably applied to floors of various vehicles so that the manufacturing cost thereof may be reduced.

Hereinabove, although the present disclosure has been described with reference to exemplary embodiments and the accompanying drawings, the present disclosure is not limited thereto but may be variously modified and altered by those skilled in the art to which the present disclosure pertains without departing from the spirit and scope of the present disclosure claimed in the following claims.

What is claimed is:

1. A passenger ingress and egress assistance apparatus, comprising:
a case having a cavity defined therein;
a moving body configured to move in the cavity of the case in a longitudinal direction of the case;
a platform configured to be stowed in and deployed from the cavity of the case by a movement of the moving body;
a hinge mechanism configured to pivotally connect the platform to the moving body; and
a step device disposed at a leading portion of the platform, the step device comprising a step body that is parallel to the platform and a plurality of step bars pivotally connecting the step body to the leading portion of the platform.

2. The apparatus according to claim 1, wherein the step body is configured to move between a retracted position in which the step body is overlapped with the leading portion of the platform and an extended position in which the step body is extended from the leading portion of the platform.

3. The apparatus according to claim 1, wherein:
a top end of each step bar is pivotally connected to the platform through a first pivot pin; and
a bottom end of each step bar is pivotally connected to the step body through a second pivot pin.

4. The apparatus according to claim 1, wherein:
the step device further comprises a safety cover pivotally mounted on a leading portion of the step body.

5. The apparatus according to claim 4, wherein the step device further comprises a skirt pivotally mounted on a bottom edge of the safety cover.

6. The apparatus according to claim 5, wherein the skirt comprises a roller device disposed at a bottom edge thereof.

7. The apparatus according to claim 6, wherein the roller device comprises:
a bracket fixed to the bottom edge of the skirt; and
a roller rotatably mounted on the bracket.

8. A passenger ingress and egress assistance apparatus, the apparatus comprising:
a case having a cavity defined therein;
a moving body configured to move in the cavity of the case in a longitudinal direction of the case;
a platform configured to be stowed in and deployed from the cavity of the case by a movement of the moving body;
a hinge mechanism configured to pivotally connect the platform to the moving body; and
a step device disposed at a leading portion of the platform, the step device comprising:
a step body that is parallel to the platform;
a plurality of step bars pivotally connecting the step body to the leading portion of the platform, wherein the plurality of step bars comprises a first step bar and a second step bar connecting the platform and the step body; and
an actuator configured to move the first step bar.

9. The apparatus according to claim 8, wherein the step device further comprises a slider bar pivotally connecting the second step bar to the step body.

10. The apparatus according to claim 8, wherein:
the step device further comprises a safety cover pivotally mounted on a leading portion of the step body; and
the safety cover is configured to move between a cover position in which the safety cover is vertically unfolded to cover a leading opening of the step body and an uncover position in which the safety cover is folded toward the step body to uncover the leading opening of the step body.

11. The apparatus according to claim 10, wherein the step device further comprises a link mechanism operably connected to the second step bar.

12. The apparatus according to claim 11, wherein the link mechanism comprises a cover pin connected to the safety cover, a first link pivotally connected to the cover pin, a second link pivotally connected to the first link, and a spring elastically connecting the second link and the second step bar.

13. The apparatus according to claim 10, further comprising a moving mechanism configured to move the safety cover to the uncover position in a state in which the platform is close to a ground surface.

14. The apparatus according to claim 13, wherein:
the safety cover comprises a guide projection protruding from a bottom edge thereof; and
the guide projection extends in a direction inclined with respect to the safety cover at a predetermined angle.

15. The apparatus according to claim 14, wherein the moving mechanism comprises:
a wheel assembly configured to move between an upward position in which the wheel assembly pushes the guide projection and a downward position in which the wheel assembly is spaced apart downward from the guide projection; and
a guide bracket fixed to the step body and configured to guide upward and downward movements of the wheel assembly.

16. The apparatus according to claim 15, wherein the wheel assembly comprises:
a pair of legs spaced apart from each other;
a wheel rotatably mounted between bottom ends of the pair of legs; and
a guide pin mounted between top ends of the pair of legs.

17. The apparatus according to claim 16, wherein:
the guide bracket comprises a pair of side walls and a top wall connecting top ends of the pair of side walls;
each side wall has a guide slot extending vertically; and
the guide pin of the wheel assembly is configured to move along the guide slot.

18. The apparatus according to claim 10, wherein the step device further comprises a skirt pivotally mounted on a bottom edge of the safety cover.

19. The apparatus according to claim 18, wherein the skirt comprises a roller device disposed at a bottom edge thereof.

20. The apparatus according to claim 19, wherein the roller device comprises:
a bracket fixed to the bottom edge of the skirt; and
a roller rotatably mounted on the bracket.
